(19) United States
(12) Patent Application Publication
(10) Pub. No.: US 2003/0065552 A1
(43) Pub. Date: Apr. 3, 2003

(54) Interactive beauty analysis

(76) Inventors: Gilles Rubinstenn, Paris (FR); Francis Pruche, Senlis (FR)

Correspondence Address: FINNEGAN, HENDERSON, FARABOW, GARRETT & DUNNER, L.L.P., 1300 I Street, N.W., Washington, DC, 20005-3315, US

(21) Appl. No.: 10/024,481

(22) Filed: Dec. 21, 2001

Related U.S. Application Data
(60) Provisional application No. 60/325,559, filed on Oct. 1, 2001.

(51) Int. Cl. G06F 17/60

(52) U.S. Cl. 705/10

(57) ABSTRACT

A method of performing a beauty analysis is disclosed. The method includes providing in a data structure a plurality of questions related to beauty, enabling a subject to access a system for presenting at least some of the plurality of questions to the subject, enabling presentation to the subject of directions for conducting at least one physical self-test, providing instructions to the subject on how to furnish information reflecting results of the self-test, and enabling selection, from the plurality of questions, of a subset of questions to be presented to the subject. A number of questions contained in the subset and identities of questions contained in the subset may be a function of the furnished information.

### BACKGROUND OF THE INVENTION

1. Field of the Invention

The invention relates to methods, combinations, apparatuses, and systems for conducting beauty analyses. In one example, the invention may integrate the use of at home self-testing with on-line diagnostics.

2. Description of Related Art

Although the invention, in its broadest sense, is not limited to beauty products, this patent uses the beauty product example for purposes of conveying to the reader some of the principles of the invention.

Consumers today are faced with numerous choices of beauty products, which can make the selection of an appropriate beauty product a daunting task. Product claims on packaging, product descriptions, or advertisements may promise particular results. However, the effectiveness of a product may vary based on physical, physiological, and/or biological characteristics of the user. Dermatologist, cosmetologist, skin/hair care expert, or other reliable professionals have experience and/or quantitative tools to help a subject select appropriate cosmetic products, but not every consumer has access to such skilled individuals. Further, heretofore, personalized-quantitative analysis may not have been considered compatible with electronic channels of commerce.

### SUMMARY OF A FEW ASPECTS OF THE INVENTION

Methods, combinations, apparatus, systems, and articles of manufacture consistent with the features and principles of the present invention perform beauty analysis.

One exemplary aspect of the present invention may involve a method of performing a beauty analysis. The method may include storing in a data structure a plurality of questions related to beauty. At least some of the questions may then be presented to a subject, along with directions for conducting at least one physical self-test. The subject may then be provided with instructions on how to furnish information reflecting results of the self-test. Based, perhaps in part on the self-test results, a subset of questions may be selected for presentation to the subject.

A second exemplary beauty analysis method may further include identifying a second question subset chosen from the plurality of questions, wherein a make-up of the second question subset is at least partially a function of the furnished information from a first question set. At least one beauty product may then be prescribed to the subject as a function of the first response set, the second response set, and the information reflecting results of the physical self-test.

A third exemplary aspect may include selecting from a plurality of testing materials, at least one customized set of testing material for determining quantitative information that would aid in recommending one or more beauty products to the subject. Thereafter, a customized diagnostic kit containing the customized set of testing material, may be transmitted to the subject. The subject can use the kit to ascertain the desired quantitative information by collecting data derived from self-testing. Based on the received answers and the ascertained quantitative information, at least one beauty product can be recommended to the subject.

A fourth exemplary aspect relates to a beauty analysis method including accessing a data structure containing a plurality of questions; presenting to the subject at least one of the plurality of questions; receiving at least one answer to the at least one question; based on the received at least one answer, identifying at least one physical test to be conducted on the subject, the test providing results relating to a beauty analysis; and instructing the subject to perform the test. Optionally, this aspect might also include receiving information reflective of the results of the test; and based on the information, selecting a sub-set of questions from the plurality of questions for presentation to the subject.

A fifth exemplary aspect relates to a beauty analysis method including presenting to a subject directions for conducting at least one physical self-test; receiving information reflecting results of the test; selecting, from a plurality of questions stored in a data structure, at least one question to be presented to the subject, wherein the selecting of one question is a function of the received information; and presenting the at least one selected question to the subject.

A sixth exemplary aspect relates to a beauty analysis method including presenting at least one question to a subject; receiving a response to the at least one question; identifying, as a function of the response, at least one physical self-test to be conducted by the subject; presenting directions for conducting the at least one physical self-test to the subject; receiving information reflecting results of the physical self-test; and prescribing at least one beauty product to the subject as a function of at least the information reflecting results of the physical self-test.

A seventh exemplary aspect involves a beauty diagnostic method, including asking a subject personal questions on at least one topic including characteristics of at least one external body condition of the subject; receiving answers to the personal questions; based on the received answers, selecting from a plurality of testing materials, at least one customized set of testing material for determining quantitative information that would aid in recommending at least one beauty product to the subject; and informing the subject about said at least one customized set of testing material.

An eighth exemplary aspect involves a diagnostic method, including receiving information regarding at least one external body condition of a subject; based on the received information, selecting at least one customized set of testing material from a plurality of testing materials; and informing the subject about the at least one customized set of testing material.

Further aspects relate to systems for implementing various methods and computer program products including computer readable media having computer readable code, wherein the computer program product includes computer readable program code for effecting actions in a computing platform.

Additional aspects of the invention are set forth in the description which follow and, in part, are obvious from the description, or may be learned by practice of methods, combinations, devices, systems, and articles of manufacture consistent with features of the present invention. It is understood that both the foregoing descriptions and the following detailed description are exemplary and explanatory only and are not restrictive of the invention.

### BRIEF DESCRIPTION OF THE DRAWINGS

The accompanying drawings, which are incorporated in and constitute a part of this specification, illustrate several aspects of the invention and, together with the description, serve to explain the principles of the invention. In the drawings,

FIG. 1 illustrates a first exemplary flow chart for facilitating analysis of an external body condition consistent with features and principles of the present invention;

FIG. 2 illustrates an exemplary interactive simulation consistent with features and principles of the present invention;

FIG. 3 illustrates an exemplary diagnostic kit consistent with features and principles of the present invention;

FIG. 4 illustrates an exemplary image for instructing the subject to furnish information reflecting results of a self-test consistent with features and principles of the present invention;

FIG. 5 illustrates a second exemplary flow chart for performing a beauty analysis consistent with features and principles of the present invention;

FIG. 6 illustrates an exemplary inventory of packages containing test materials consistent with features and principles of the present invention;

FIG. 7 illustrates a third exemplary flow chart for performing a beauty diagnosis consistent with features and principles of the present invention;

FIG. 8 illustrates an exemplary method for creating a customized diagnostic kit consistent with features and principles of the present invention; and

FIGS. 9A and 9B illustrate exemplary environments consistent with features and principles of the present invention.

### DESCRIPTION OF EXEMPLARY EMBODIMENTS

Reference is now made in detail to exemplary embodiments of the invention, examples of which are illustrated in the accompanying drawings. Wherever possible, the same reference numbers are used throughout the drawings to refer to the same or like parts.

One embodiment of the invention may include a method for performing a beauty analysis. Typically, a beauty analysis may involve gathering information from a subject under analysis. The invention, in one respect, involves mechanisms for facilitating such information gathering. Information may be gathered, for example, through questions presented to the subject, or one or more self-tests administered by the subject. Answers to at least some of the questions and results of at least some of the self-tests may be used to determine an external body condition and prescribe an appropriate beauty product. Examples of external body conditions may include a particular skin texture, skin elasticity, skin or hair dryness, cellulitis, sweating, aging, wrinkles, melanoma, exfoliation, desquamation, homogeneity of skin or hair color, hair thickness, hair density, dandruff, micro-circulation, skin or hair shininess, skin or hair softness, skin or hair smoothness, hydration, sebum production, skin or hair cleanliness, irritation, redness, vasomotion, vasodilation, vasoconstriction, pigmentation, freckles, baldness, thinning hair, size and proportion of facial features, or any other visible external body condition. The question may relate to genetic information (e.g., family history of hair conditions, such as hair whitening, and/or family history of skin conditions, such as melanoma), health risks, and/or sensitivity of the skin.

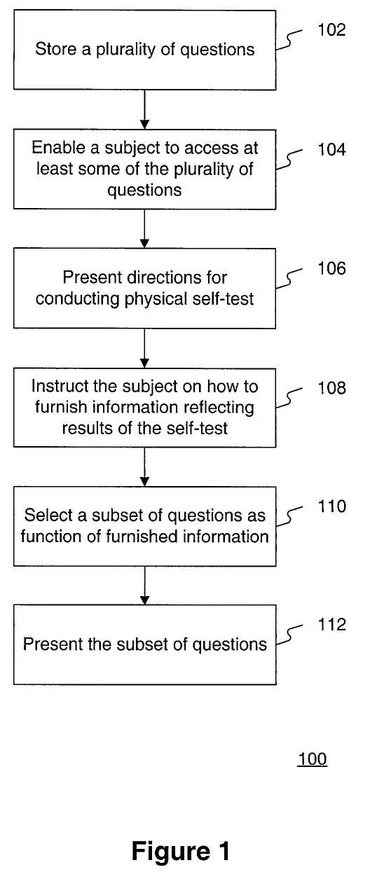

Consistent with the invention, the method may include storing in a data structure a plurality of questions related to beauty. As illustrated in flow chart 100 of FIG. 1, the plurality of questions may be stored in a data structure at step 102 using a storage medium. Examples of storage medium may include magnetic storage devices, such as floppy disks, lomega zip disks, and tapes, optical storage devices, such as compact discs and digital video discs, organic storage devices, random access memory, read only memory, printed media, or any other medium for storing information. As embodied herein, storing may also include outsourcing storage functions to a third party vendor to store at least some of the plurality of questions. The plurality of questions may be stored at one or more locations, in one or more types of storage medium. The storage medium may be provided at a location remote from the subject, may be electronically or physically transmitted to the subject, or may be stored locally on a system used by the subject.

Consistent with the invention, the plurality of questions may be phrased to elicit information regarding a subject's physical characteristics, lifestyle, demographics, environment, sun exposure level, nutrition, medical history, cosmetic usage, or any other information useful in evaluating a subject for a beauty product. Questions regarding physical characteristics may relate to a subject's age, weight, height, ethnicity, size and proportion of facial features, eye color, hair color, hair texture, hair volume, hair processing, hair shininess and/or softness, hair oiliness/dryness, balding, cellulite, wrinkles, moles, freckles, age spots, facial hair, pore size, skin elasticity, skin oiliness/dryness, skin shininess, skin smoothness, skin color, skin type, vasomotion, vasodilation, vasoconstriction, skin discoloration, and skin tone, and any other external body condition. Questions regarding lifestyle may relate to habits of working, sleeping, exercise, relaxation, cleansing and moisturizing, exfoliation, smoking, and drinking. Questions regarding demographics may relate to a geographic location where the individual resides, works, or vacations. Questions regarding environment may relate to the use of sunscreen, intensity and frequency of sun exposure, and the number of sunburns and serious sunburns. Questions regarding nutrition may relate to eating habits including types, quantity, and frequency of foods eaten, dietary restrictions, as well as any dietary supplements or vitamins taken. Questions regarding medical history may relate to a diagnosed condition affecting the external body, such as melanoma. Questions regarding cosmetic usage may relate to the types of beauty products used by the subject and a frequency of usage. In essence, the queries may be designed to elicit any personal information that aids in prescribing a beauty product.

Also consistent with the present invention, a method may include enabling a subject to access a system for presenting at least some of the plurality of questions, as graphically depicted at step 102 in FIG. 1. As used herein, the phrase “enabling . . . access” may include one or more of providing access over a network to at least some of the plurality of questions, creating or distributing software to the subject configured to run on the subject's workstation or computer, or creating or distributing at least some of the plurality of questions to the subject by physical, telephonic, or electronic delivery. A first party may operate alone or in cooperation with a third party vendor to enable a subject to access a system for presenting the at least some of the plurality of questions. The system may be provided at a location local or remote the subject.

Consistent with the invention, a first party may host a website or contract a third party vendor to host a website for enabling a subject to access a system when the subject's workstation accesses the website over a network. As embodied herein, the network may include one or more local area networks, wide area networks, metropolitan area networks, or any other type of network suitable for interfacing a host website with the subject's workstation. The network may include one or more of wired and wireless connections. The network may also include a combination of public networks, such as the Internet, and private networks, as well as virtual private networks. One skilled in the art can readily appreciate that any number of geographically dispersed workstations may connect to the network and couple with a host website. In its broadest sense, the system of the invention may include any mechanism that causes questions to be displayed to a subject, regardless of technology.

Also consistent with the invention, a first party and/or third party vendor may enable system access by creating or distributing to the subject a floppy disk, tape, compact disc, digital video disc, organic storage device, lomega zip disk, or any other storage medium containing software configured to run on the subject's workstation and present the subject with at least some of the plurality of questions. The subject's workstation may be embodied within a home computing system, may be located in a kiosk, or may be part of a processing system run by professionals in a salon, place of business or retail establishment. As embodied herein, the software configured to run on subject's computer may be delivered to the subject using a courier, Federal Express, United Parcel Service, United States Postal Service, or any other public or private delivery service. In addition, the subject may receive the software by downloading it from a host website, by having it delivered at subject's workstation using file transfer protocol (FTP), by receiving it as an attachment in an e-mail message, or any other effective means for obtaining the software.

Also consistent with the invention, a first party and/or third party vendor may enable a subject to access a system by presenting at least some of the questions to the subject in hard copy form. The subject may access the questions by facsimile, by mail or courier, or by picking up the questions at a designated location, such as a store or salon carrying at least one beauty product. A first party and/or third party vendor also may enable a subject to access a system by providing the questions telephonically to the subject. The method may deliver a telephone number for a subject to call to receive at least some of the plurality of questions, or the subject may be called by a representative, such as a telemarketer.

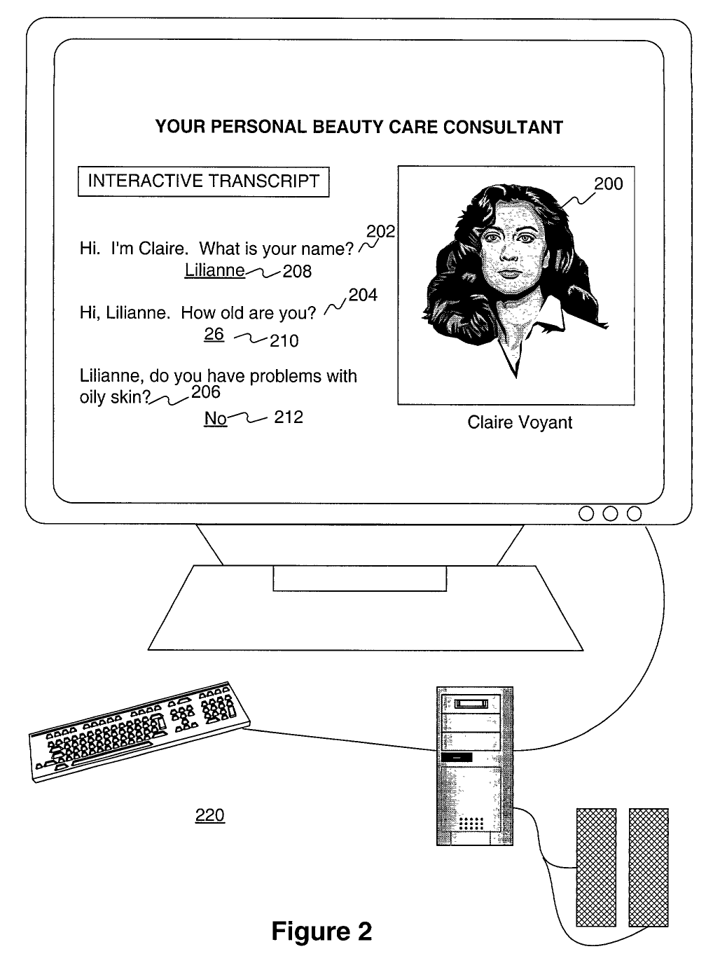

Enabling a subject to access a system may include presenting questions electronically in a text document created by a word processing application or other suitable application, or embedding questions electronically in an interactive software simulation. While any mechanism for presenting questions may be encompassed by the invention in its broadest sense, FIG. 2 illustrates one possible mechanism. As illustrated, an interactive simulation may run on a subject's computer 220 or on a remote server (not shown) to simulate a human 200 or other character asking the subject one or more questions 202, 204, and 210 and receive responses 208, 210, and 212 from the subject.

Consistent with the present invention, a method may further include presenting directions to the subject for conducting at least one physical self-test. A corresponding step is illustrated at step 106 in FIG. 1. The phrase “presenting directions” may include one or more of transmitting instructions to the subject over a network, providing instructions to the subject in the form of software, and providing instructions to the subject in hard-copy form. Examples of transmitting instructions to the subject over a network may include downloading directions for conducting one or more self-tests from a host website for viewing, printing, and/or storing at the subject's workstation. As used herein, “host website” may include a third party vendor website. Additionally, a processor of host website may transfer the instructions to an IP address of the subject's computer using a file transfer protocol.

The directions may be textual, visual, or a combination thereof. The directions may be provided in an electronic or physical document, or embedded in a software simulation. The simulation may simulate a human or other character instructing the subject for conducting at least one physical self-test in a more personal manner than plain text. The simulation may be interactive to further increase a degree of intimacy with the subject and increase customer satisfaction.

Also consistent with the invention, presenting directions to the subject for conducting at least one physical self-test may include providing instructions to the subject in the form of software. The subject may receive a storage medium which includes an electronic version of the directions for conducting at least one physical self-test. The software may provide the directions in a textual format or it may provide the directions through an application, as described above.

Presenting directions to the subject for conducting at least one physical self-test may include providing instructions to the subject in hard-copy form. For example, the instructions may be physically transmitted to the subject using a courier, Federal Express, the United States Postal Service, or any other public or private delivery service. Alternatively, the directions may be picked up by subject at a location where one or more beauty products are sold, e-mailed or facsimiled to the subject. In addition, the subject may call an information line to receive directions telephonically by an automated voice recognition unit or a human operator. In one example of the invention, the instructions may be provided to the subject together with materials for conducting a self-test.

Alternatively, presenting directions to the subject for conducting the physical self-test may include instructing the subject to gather materials for conducting the self-test. The materials may include common household items, such as paper, detergents, a tape measure, and a mirror. For example, the subject may be instructed to rub a piece of paper across a forehead region to determine an amount of oil. Similarly, a subject may be instructed to measure an amount skin on the face or arm may be stretched to determine skin elasticity. One can envision numerous tests using common household items for quantifying an external body condition. As used herein, the term “physical” self-test may include any test that obtains information about physical, physiological, and/or biological characteristics of an individual.

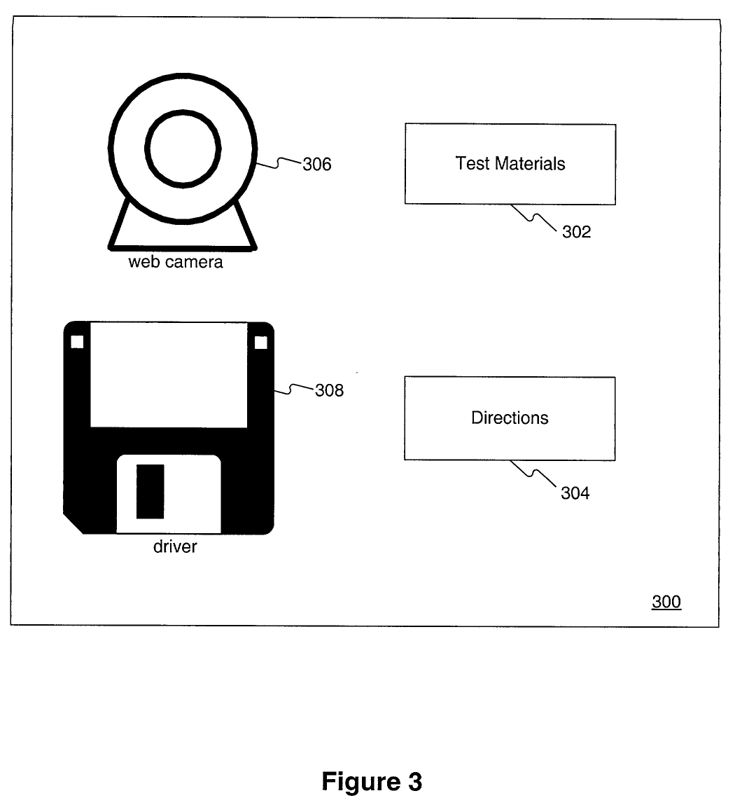

Also consistent with the present invention, a method may include causing physical transmission to the subject of a package containing materials for conducting the at least one test. FIG. 3 schematically illustrates diagnostic kit 300, which may contain one or more test materials 302 for conducting the at least one test and/or directions 304 for conducting the at least one test. Kit 300 may be delivered to the subject using a courier, Federal Express, the United States Postal Service, or any other public or private delivery service. In an alternative embodiment, the subject may pick up kit 300 at a designated location, such as at a store selling one or more beauty products.

Test materials 302 may include at least one of a pH indicator, sebutape, a d-squame disc, and a corneodisque indicator. The subject may use a pH indicator, according to the electronic or hard-copy instructions, to test a pH value of the skin and/or scalp. Similarly, the subject may use sebutape to remove sebum and other lipids from the surface of the skin or scalp, thereby indicating skin oiliness. A d-squame disc may be used to remove flakes from the surface of the skin or scalp, thereby indicating skin dryness. A corneodisque indicator may leech water from the surface of the epidermis, thereby indicating the moisture/humidity content of the epidermis.

An example of directions for using sebutape and d-squame discs may include instructing the subject to remove the sebutape or d-squame disc from a card, place an index finger behind the tape or disc, place the tape or disc firmly against the forehead, and remove. The directions may instruct the subject to repeat the procedure for the cheek area, using another piece of sebutape. The directions may further specify a time for using the materials. For example, the directions may instruct the subject to wait a designated amount of time after exercising, washing, or applying any beauty products before performing the test. In one embodiment, the directions may instruct the subject to perform the sebutape measurements on a forehead, chin, and cheek area at least five hours after washing the face and applying no moisturizers, make-up or other beauty product to the skin. Directions for the corneodisque indicator and pH indicator may be of a similar nature.

Sebutape, d-squame discs, corneodisque indicators, and pH indicators are inexpensive materials that are easy to use and accurately assess skin type. Other test materials may include ion detectors, mineral detectors, organic detectors, and/or any device capable of measuring a physical, physiological and/or biological parameter. By providing such tests, a vendor may remove the guess work involved in determining a skin type and provide direct visual evidence to the subject for a relatively low cost. Further, the materials may serve as an interactive marketing tool to engage the subject, educate the subject, and improve customer satisfaction.

Other tests of varying cost and scope may also be provided to the subject. For example, test materials 302 may include a device to measure skin elasticity. Similarly, test materials 302 may include hormone tests and enzymatic tests. Test materials may also include various color charts (in hard or soft form), which a subject may use to compare with an external body condition. For example, the subject may use such charts to determine a skin or hair tone, skin or hair color, amount and intensity of wrinkles, acne, balding, hairiness, and/or freckles by selecting the chart that most closely represents an external condition of the subject. Similarly, skin sensitivity may be measured by comparing a pattern of broken blood vessels or capillaries to a chart. The comparison may be completed after applying a particular product to the skin to increase effectiveness. In addition, test materials 302 may include materials for the subject to compare with a texture of the skin to determine a roughness level of the skin.

Examples of other test materials are disclosed in provisional application No. 60/331,003, filed on Nov. 6, 2001, and entitled DISPOSITIF DE MESURE ET/OU D'ANALYSE D'AU MOINS UN PARAMETRE D'UNE PORTION EXTERNE DU CORPS HUMAIN, the disclosure of which is incorporated herein by reference. Such test material may be formed at least partially of ceramic material, for example.

Also consistent with the invention, test materials 302 may include a voucher or other authorization for having one or more tests conducted at a testing facility. The directions for conducting the tests performed by a vendor may include listing available testing facilities and instructing the subject to redeem the voucher at one of the listed testing facilities. As embodied herein, the testing facility may use at least one of a corneometer for measuring a water content of subject's scalp or skin, a cutometer for measuring skin elasticity, a mexameter for measuring a melanin index and hemoglobin (erythema) index of skin, a sebumeter for measuring sebum content of scalp or skin, skin-pH meter for measuring pH of skin or scalp, skin visiometer for measuring skin roughness, sun protection diagnostic to perform an SPF analysis, tewameter to measure trans-epidermal water loss, visioscan to evaluate the skin surface, chromameter to measure skin clarity or luminosity, impedance measurements to measure skin moisture, a gas bearing electrodynamometer to measure skin softness and suppleness, skin replicas or image analysis to measure skin surface smoothness or texture, TEWL to measure skin barrier function, laser doppler to measure blood flow or skin sensitivity, ultrasound to measure skin and fatty tissue thickness, lesion counting and bacteriology to study acne, and ballestometry to measure skin firmness. Hair moisture and suppleness, hair tensile strength, penetration of actives into hair, hair deposition, and UV protection may also be determined. The tests and test materials described above are not intended to be inclusive, it being understood that tests and test materials, as used herein, are intended to cover any method and product for evaluating an external body condition.

While not a requirement of the invention in its broadest sense, diagnostic kit 300 may further include an image capture device 306 and a driver 308 for the image processing device, as shown in FIG. 3. Consistent with the invention, image capture device 306 may include a web camera, analog camera, a digital camera, a flat bed scanner, a film scanner, ultra-sound imaging device or any other device suitable for capturing an image of the subject and transferring the image electronically to the subject's workstation. Driver 308 may include any software for operating image capture device 306. Driver 308 may further include software for analyzing an image captured by image capture device 306 to determine an external body condition.

Consistent with the invention, presenting directions to the subject for conducting at least one physical self-test may include encouraging the subject to conduct an auto-evaluation using the image capture device. The phrase “encouraging the subject” may include providing instructions to the subject. For example, the directions may instruct the subject to capture a self-image in a room having at least one of a prescribed temperature range, humidity range, and a lighting range. The subject may also be instructed to capture an image at a prescribed distance from the image capture device.

Also in accordance with the present invention, a method may include instructing the subject on how to furnish information reflecting results of the self-test. This is illustrated in step 108 of FIG. 1. The term “instructing” may include directing the subject on how to interpret the results of the self-test and directing the subject on how to provide the interpreted results to one or more of a client-based processor and a network-based processor. As embodied herein, directing the subject on how to provide the interpreted results to one or more of a client-based processor and a network-based processor may include instructing the subject to send the used test materials and/or test measurements to a laboratory or other site for processing. Alternatively, instructing the subject may include prompting the subject for information regarding visual or measured results of the test. This information may be provided by the subject electronically or verbally through a microphone connected to the subject's computer to interactive software running on the subject's computer or at a host website. Alternatively, the information may be mailed in hard-copy form, transmitted by facsimile, e-mailed, or telephonically provided to a designated location. In addition, instructing the subject may include a combination of sending the used test materials and/or test measurements to a laboratory or other site for processing and prompting the subject for information regarding visual or measured results of the test. For example, the subject may be instructed to provide information regarding some tests and instructed to send other test materials for processing. Further, for a given test, the subject may be instructed to provide visual information, and further instructed to send the results into a laboratory if the test is beyond a designated range.

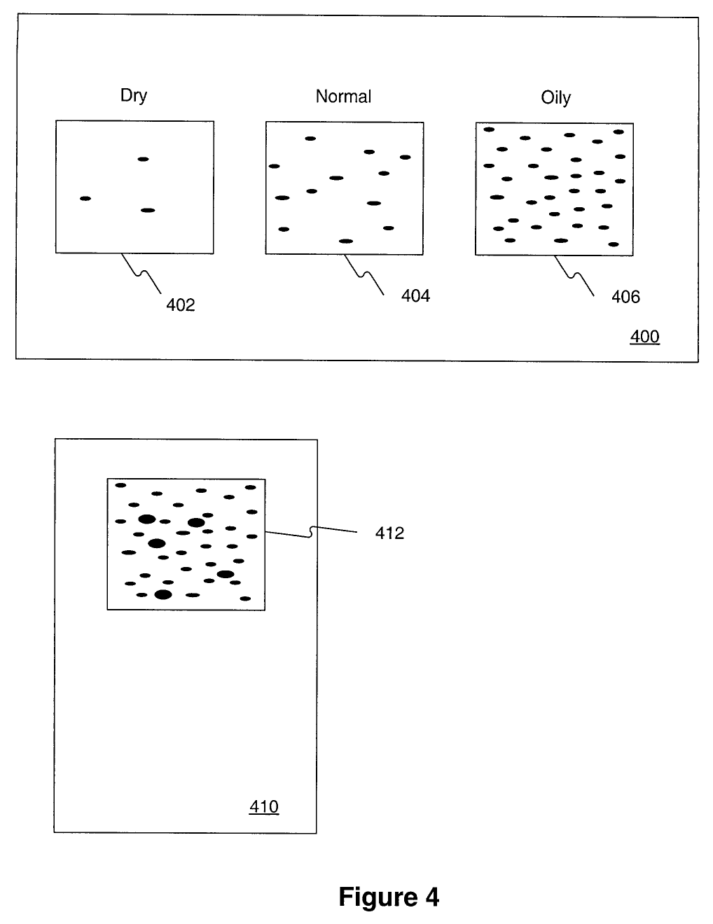

FIG. 4 illustrates an exemplary image 400 for instructing the subject to furnish information reflecting results of a self-test performed using sebutape. The subject may be asked to compare a pattern of sebum 412 on a used piece of sebutape 410 with sebum reference patterns 402, 404, and 406. After comparing the patterns, the subject may be instructed to identify a sebum reference pattern 402, 404, 406 that most closely resembles a pattern of sebum 412 on the used sebutape. In this case, the subject may select reference pattern 406, indicating an oily skin condition, by designating the selection on a hard-copy document, electronic document, telephonically, or using interactive software.

Examples of designating a reference pattern on a hard-copy document include circling, marking, or checking a particular pattern, and writing or typing one or more characters representing one of the reference patterns. The hard-copy document may be submitted by mail, hand-carried delivery, facsimile, or by electronically scanning the document to forward it electronically in an e-mail attachment or uploading the document to a host website, for example. The subject may call a designated telephone number to provide the information telephonically to a voice recognition unit or a human operator.

Examples of designating a reference pattern on an electronic document or in interactive software may include using a mouse or keyboard to select a particular pattern by clicking the pattern or an area associated with the pattern, or typing one or more characters representing one of the reference patterns into an appropriate data entry field. The electronic document or the results of the interactive software may be printed and sent by mail, facsimile, or physically delivered to a separate processing unit. Alternatively, the electronic document may be e-mailed as an attachment or sent by facsimile in electronic form to a separate processing unit. Further still, the electronic document may be submitted using a host website to upload the document. Additionally, application software running on the subject's workstation or at a remote site may receive responses submitted electronically by the subject.

Instructing the subject on how to furnish information using an image capture device may be the same as the directions for conducting a self-test using the image capture device. For example, an image processor may process a captured image without requiring any further information from the subject. Alternatively, client-side software or software stored at a location remote from a location of the subject may prompt the subject to look at the image and report information from the image. The software may prompt the subject to count a number of wrinkles in a particular location, for example. In another embodiment, an image processor may display a blurred or incomplete image of the subject and request the subject to furnish more detailed information about the image. For example, the subject may select a degree of wrinkles or an evenness of skin color, which the image processor may use to sharpen the captured image before processing. By providing a blurred image of the subject, the subject may be less offended by inaccuracies or distortions in the captured image.

Other examples of instructions provided at the subject's workstation or at a host website through interactive software may include instructing the subject to describe the color of a pH indicator after use, count the number of hairs on a pillow after sleeping, or compare a pattern of used d-squame discs or corneodisque indicators with reference patterns. One skilled in the art can readily recognize that an unlimited number of instructions may be provided to the subject for furnishing information reflecting the results of the self-test. Thus, the invention, in its broadest sense is not limited to a particular set or type of instructions.

Consistent with the invention, a method may further include selecting, from a plurality of questions, a subset of questions to be presented to the subject, wherein questions contained in the subset are a function of the furnished information. This step is exemplified by block 110 in the flow chart 100 of FIG. 1. The term “selecting” may include providing at least one of a client-based algorithm and a server-based algorithm for narrowing the plurality of questions to the subset of questions as a function of the information reflecting results of the self test. A client-based algorithm located at the subject's workstation or a server-based algorithm located at a host website may process information received regarding the results of the conducted self test, and select the appropriate subset of questions for presentation. For example, if the results of the physical test indicate an oily skin condition, subsequent questions regarding a dry skin condition may be omitted, and additional questions regarding the oily skin condition may be presented. In this manner, the subject may be presented fewer questions, which are tailored to the external body condition(s) of the subject. Likewise, if the test reveals that the subject has low skin elasticity or wrinkles, subsequent questions may inquire as to where the questions are located. The algorithm may employ artificial intelligence, a decision tree, mathematics, or any logic or intelligence based algorithm for selecting the appropriate subset of questions. One skilled in the art will readily recognize that the term “algorithm” may include program code embodied in software or hardware for effecting actions in a computing platform.

If the invention is embodied in a system that employs an image capture device, an image processor may be used to analyze the image captured by the image capture device. The image processor may perform an image analysis, for example, to determine skin surface smoothness or texture. Or, the image processor may count the number and intensity of wrinkles, moles, and freckles on an image of the subject's face. The image processor might also measure reflectivity on an image of the subject's face or hair to determine a level of skin or hair shininess. The image processor may also evaluate hair texture, skin elasticity, skin or hair dryness, cellulitis, sweating, wrinkles, melanoma, pore size, age spots, exfoliation, desquamation, homogeneity of skin or hair color, micro-circulation, skin or hair smoothness, hydration, sebum production, skin or hair cleanliness, irritation, redness, vasomotion, vasodilation, vasoconstriction, pigmentation, freckles, baldness, thinning hair, or any other visible external body condition.

Consistent with the invention, a method may further include maintaining in a data base, beauty information on a plurality of individuals, and wherein the algorithm narrows the plurality of questions to a subset of questions by comparing subject provided information with information in the data base. Such a data base may maintain (e.g., directly store or otherwise provide access to) various items of information relating to a plurality of individuals. This information may be derived from population surveys, records of interactions with a plurality of individuals, or may be based on experiences of individuals with knowledge of the beauty industry.

The data base may include correlation data between personal characteristics of the plurality of individuals and external body conditions of the plurality of individuals. Similarly, the data base may include correlation data between personal characteristics of the plurality of individuals and compatibility of beauty products with those individuals. In one embodiment, the data base may include information reflective of beauty product use, external body conditions, and personal characteristics for each of the plurality of individuals, as well as the correlation data between personal characteristics of the plurality of individuals and external body conditions or compatibility of beauty products.

Using the data base, the algorithm may compare subject provided information with the stored correlation data to narrow the plurality of questions to a subset of questions. For example, the data base may contain information reflecting a high likelihood of acne or blemishes with individuals who respond affirmatively to an oily skin condition. Thus, when a subject responds affirmatively to such a condition, the algorithm may compare the subject's response to information in the data base and, based on that comparison, present further questions regarding blemishes or acne, while suppressing questions about dry skin. Similar concepts are described in a concurrently filed application entitled, “Cosmetic Affinity Indexing,” (Attorney Docket No. 05725.0986), the disclosure of which is incorporated herein by reference.

Consistent with the invention, a method may include presenting the subset of questions to the subject. The subset of questions may be electronically presented to the subject, for example, using the previously described interactive software simulation, an electronic text document or mechanism of presenting information to the subject. For example, software or a document may be provided at a host website or physically delivered to the subject by mail, e-mail, or facsimile. The presentation of the subset of questions may also be provided in hard-copy form. For example, the subject may pick up a subset of questions at a designated location after furnishing results of the self-test, or the subject may be mailed a subset of questions. Alternatively, the questions may be presented to the subject telephonically.

Consistent with the invention, a method may further include receiving a response to one or more questions from the subject, and/or prescribing at least one beauty product to the subject as a function of at least one of the self-test information and at least some of the responses to the questions. Responses may be received by instructing the subject to complete and return a physical or electronic questionnaire by e-mail, facsimile, or mail. For example, a subject may complete a form received electronically, print the completed form, and transmit the form by facsimile to a receiving center. Alternatively, the subject may complete and submit a questionnaire on-line at a host website. Further still, the subject may provide typed or keyed responses to interactive software running on subject's workstation or at a remote location, or provide audio responses through a microphone at the subject's workstation or via a telephone network. A decision tree, neural network, or any other logic based or artificial intelligence algorithm may be employed to prescribe at least one beauty product to the subject. As used herein, the term “prescribe” may include making a recommendation, suggestion, advice, encouragement, direction, and/or order. A prescription could be made in many different ways, such as, for example, by causing perceptible information to be provided to an individual in any manner discussed herein and/or by providing the individual with a beauty product, such as a cosmetic product.

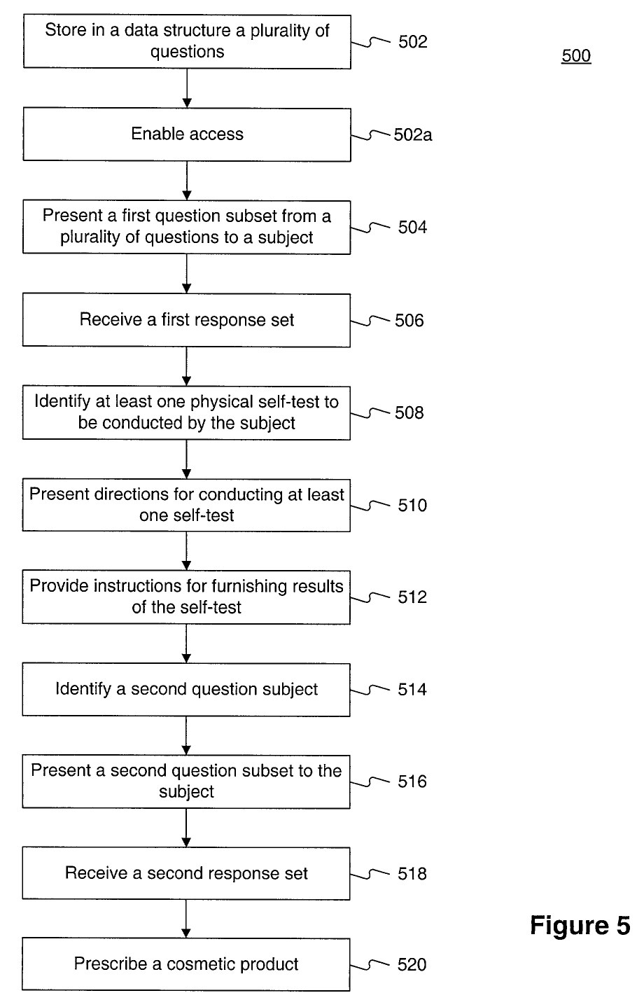

As illustrated in a flow chart 500 of FIG. 5, another embodiment of the invention may also include a method for performing a beauty analysis. Consistent with the invention, the method may include storing in a data structure a plurality of questions related to beauty (step 502) and enabling a subject to access a system for presenting at least some of the plurality of questions to the subject (step 502a). Steps 502 and 502a, graphically illustrated in FIG. 5, are similar to steps 102 and 104 in FIG. 1, described above.

Also consistent with the invention, a method may include presenting at least a first question subset from the plurality of questions to the subject and receiving a first response set to the first question subset. These steps are depicted at blocks 504 and 506 in FIG. 5. The first question subset may include questions that help identify an external body condition requiring further analysis. For example, the first question subset may include one or more questions regarding aging. If a subject responds that no signs of aging are present, then the subject, in one embodiment, may not receive further tests or inquiries regarding skin elasticity, wrinkles, or age spots. However, if a subject responds affirmatively to aging, further tests and/or questions may be presented to the subject regarding aging.

The first response set may be provided by the subject electronically, telephonically, or in hard copy form. The results may be received at a location remote from the client or by client-side software provided to the subject and configured to run on the subject's computer. As described above, the subject's computer may be embodied within a home computing system, may be located in a kiosk, or may be part of a processing system run by professionals in a salon, place of business, or retail establishment.

Consistent with the invention, a method may include identifying, as a function of the first response set, at least one physical self-test to be conducted by the subject, as shown at step 508 of FIG. 5. Identifying the at least one physical self-test may be accomplished using a selection algorithm, the selection algorithm evaluating the first response set to select at least one physical test.

For example, if the subject indicates a dry skin condition in the first response set, the selection algorithm may select test materials, such as d-squame disks, that determine a level of skin dryness, rather than test materials, such as sebutape, that determine a level of skin oiliness.

Similarly, if a subject responds that signs of aging are present, the subject may receive one or more self-tests for measuring skin elasticity, wrinkles, moisture levels, skin fattiness, and so forth, in response to a positive indication of aging. By performing further tests and/or questions to evaluate an aging condition, the method may be able to prescribe an anti-aging beauty product tailored to the subject's aging condition. This recommendation may help prevent skin aggravation (i.e., skin redness, puffiness, and irritation) that often occurs when young women, at the first signs of aging, overzealously apply an arsenal of anti-aging beauty products designed for a sixty year old woman, for example.

As used herein, the selection algorithm for identifying the physical self-test may employ artificial intelligence, a decision tree, or any other type of logic for identifying the physical self-test.

Also consistent with the invention, the method may further include maintaining in a data base, beauty information on a plurality of individuals, and wherein the algorithm compares information about the subject with information in the data base. The data base may include beauty information for numerous individuals, detailing responses to a plurality of questions, results from physical tests, and/or beauty products used. By comparing the subject's responses the data base, the algorithm may determine a set of individuals having one or more external body conditions that most closely resembles the subject and may select a self-test that conveys the most useful information about the subject's external body condition.

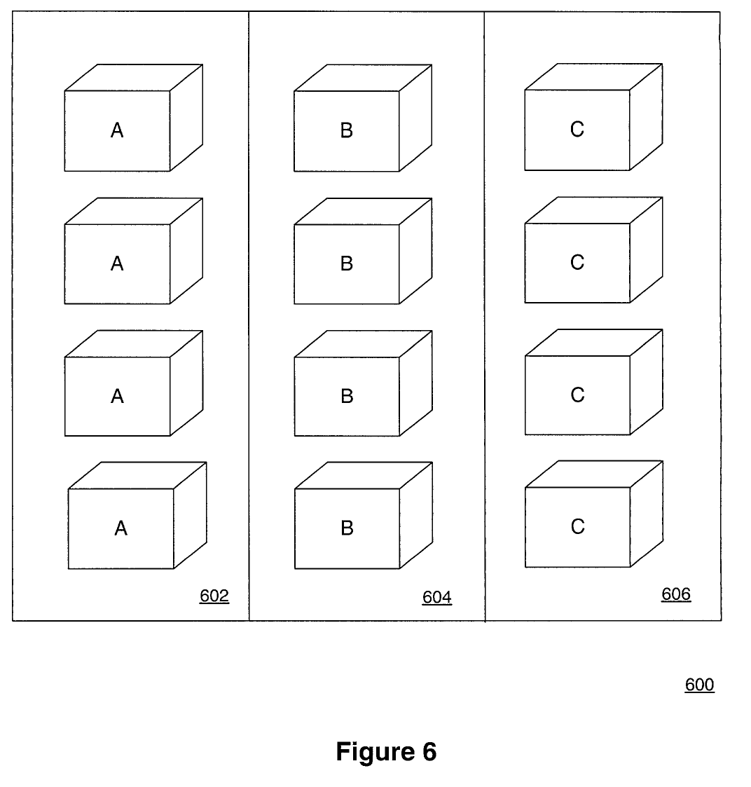

Consistent with the invention, a method may include causing physical transmission to the subject of a package containing materials for conducting the at least one physical self-test. FIG. 6 is an exemplary inventory 600 of A-type packages 602, B-type packages 604, and C-type packages 606 containing test materials A, B, and C, respectively. After receiving a first response set, the method may select one or more of packages 602, 604, and 606 to send to the subject or to allow the subject to pick-up at a designated location. A customer who indicated an aging condition may receive an A-type package 602, having skin elasticity test materials, while a customer with an oily skin condition may receive a B-type package 604, having sebutape test materials. The package may contain any one or more of the test materials described above in reference to the first embodiment. In this way, customized test kits may be sent to consumers. Alternatively, each test kit may be individually assembled to each customer's needs.

Also consistent with the invention, a method may include presenting directions for conducting the at least one physical self-test and instructing the subject on how to furnish information reflecting results of the self-test. These steps, depicted as steps 510 and 512 in FIG. 5, are similar to previously described steps 106 and 108 in FIG. 1. For example, as described above in reference to a prior embodiment, enabling presentation of directions for conducting at least one physical self-test may include at least one of transmitting instructions to the subject over a network, providing instructions to the subject in the form of software, and providing instructions to the subject in hard-copy form. Similarly, instructing the subject on how to furnish information may include directing the subject on how to interpret the results of the self-test and directing the subject on how to provide the interpreted results to one or more of a client-based processor and a network-based processor.

Consistent with the present invention, a method may include identifying a second question subset chosen from the plurality of questions, wherein a make-up of the second question subset is at least partially a function of the furnished information. This step is shown in block 514 of FIG. 5, and may use processing similar to that disclosed in reference to step 110 of FIG. 1. Identifying a second question subset may be accomplished using a selection algorithm. For example, a client-based algorithm located at the subject's workstation or a server-based algorithm located at a host website may process information received regarding the results of the conducted self test, and select the appropriate second question subset for presentation. As described earlier, the selection algorithm may include artificial intelligence, a decision tree, mathematics, or any logic or intelligence based algorithm for selecting the appropriate subset of questions. The method may further comprise maintaining in a data base beauty information on a plurality of individuals, and wherein the algorithm compares information about the subject with information in the data base, as described above in reference to the prior embodiment.

Consistent with the present invention, a method may include presenting the second response set to the subject and receiving a second response set to the second question subset, as illustrated in steps 516 and 518 of FIG. 5. The second response set may be presented and received using any physical, electronic, or telephonic means, as described above in relation to the first embodiment.

Consistent with the present invention, a method may include prescribing at least one beauty product to the subject as a function of the first response set, the second response set, and the information reflecting results of the physical self-test. This is graphically illustrated as step 520 of FIG. 5. The beauty product may be selected using a selection algorithm. As previously discussed, the selection algorithm may employ artificial intelligence, a decision tree, or any suitable logic or intelligence.

A method consistent with the invention may further comprise maintaining in a data base beauty information on a plurality of individuals, and the algorithm may compare information about the subject with information in the data base. For example, the data base may include information on a plurality of individuals. The information may include first response sets, second response sets, and information reflecting results from at least one physical self test for each individual, along with at least one beauty product used by that individual. The beauty product stored in association with each individual may include a product identified by an individual as satisfactory, highly satisfactory, or unsatisfactory, or a product identified by a software program as appropriate for a given condition or set of conditions.

A method consistent with the invention could include accessing a data structure containing a plurality of questions. There are many different ways in which a data structure could be accessed. For example, a data structure could be accessed by obtaining information from the data structure in any known matter regardless of the configuration of the data structure or its location.

An alternative embodiment of the invention may include a combination. Consistent with the invention, the combination may include at least one tool for gathering information related to beauty. For example, the tool may be configured to gather physical information, physiological information, and/or biological information. The at least one tool may include at least one of a pH indicator, sebutape, and a corneodisque indicator. The at least one tool may further include any of the test material described in reference to prior embodiments. Also consistent with the invention, the combination may further include an image capture device for capturing an image of an external body condition of a subject. Consistent with the invention, the combination also may include a driver for driving the image capture device to capture a facial image of a subject, wherein the image capture device, the driver and the at least one tool are packaged and distributed together in order to facilitate an electronic beauty analysis.

In an alternative embodiment, the combination may include a driver and at least one tool, without the image capture device. For example, the subject may already have an image capture device. A driver may supplement or enhance the image capture device the subject already has, or the driver may drive a new image capture device. In another embodiment, the combination may include the at least one tool, without an image capture device or a driver for driving the image capture device.

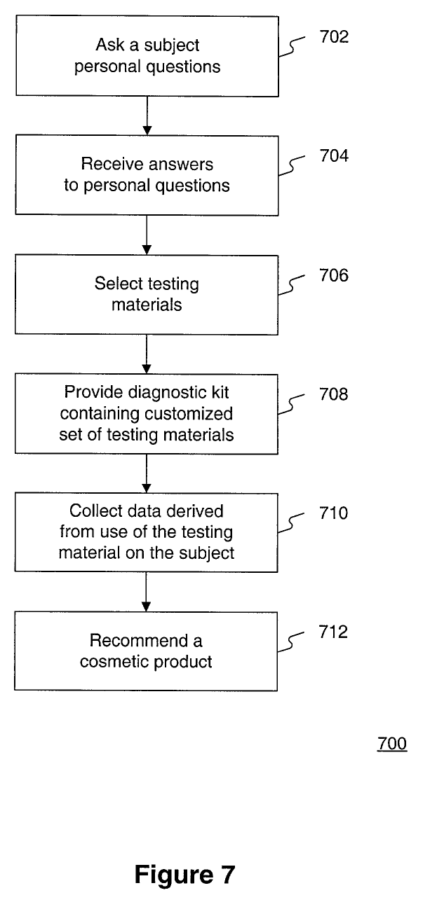

Another embodiment of the invention may include a method for performing a beauty diagnosis. Consistent with the invention, the method may include asking a subject personal questions on at least one topic including characteristics of at least one external body condition of the subject. This step is exemplified by block 702 in the flow chart 700 of FIG. 7. Exemplary questions are provided above in reference to block 102 in the flow chart 100 of FIG. 1. The subject may be asked questions electronically, telephonically, or in hard copy form, as described above in reference to block 104 in the flow chart 100 of FIG. 1. For example, as elaborated above, the questions may be electronically posed over a network or provided locally to the subject on client-based software.

Consistent with the present invention, the method may further include receiving answers to the personal questions and, based on the received answers, selecting from a plurality of testing materials, at least one customized set of testing material for determining quantitative information that would aid in recommending one or more beauty products to the subject. These steps are shown as blocks 704 and 706 in the flow chart 700 of FIG. 7.

Consistent with the present invention, the method may further include informing the subject about the selected customized set of testing material. The “informing” could take place by causing perceptible information to be provided to the subject in any manner discussed herein and/or providing the subject with the customized set itself.

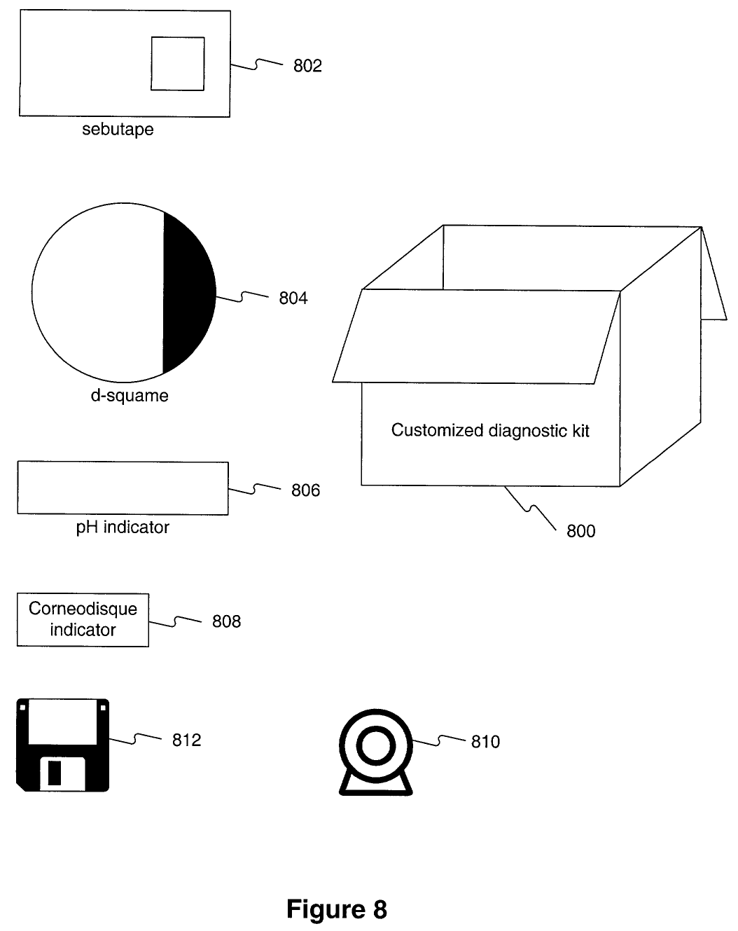

FIG. 8 illustrates an exemplary method for assembling a customized kit 800. Based on the subject's answers to the personal questions, one or more of sebutape 802, d-squame disks 804, pH indicators 806, and a corneodisque indicator 808 may be selected as a customized set of testing materials for the subject, placed in the kit 800, and delivered to the subject. An image capture device 810 and a driver 812 for the image capture device may also be placed in the kit. The kit 800 may be transmitted to the subject via a courier or other delivery means, or picked up by the subject at a designated location, as shown in step 708 of FIG. 7. The customized kit 800 may include material sufficient to conduct a single test or material sufficient to conduct multiple tests.

Alternatively, the customized kit may be provided by maintaining an inventory of a plurality of differing groups of test kits, each group containing a combination of tests different from a combination in another group. This embodiment is shown in FIG. 6, wherein groups 602, 604, and 606 contain different combination of tests. Thus, providing the subject with a customized test kit may include selecting and shipping an appropriate test kit 602, 604, or 606 from a group maintained in inventory.

Consistent with the invention, the method may include ascertaining the desired quantitative information by collecting data derived from use of the testing material on the subject. This is shown in step 710 of FIG. 7. The data derived from use of the testing materials may be provided electronically, physically, or telephonically, as described in detail above with reference to the first embodiment.

Consistent with the invention, the method also may include recommending at least one beauty product to the subject based on the received answers and the ascertained quantitative information, as depicted at step 712 in FIG. 7. The beauty product may be selected using a selection algorithm, described above in reference to the first and second embodiments. The selection algorithm may employ artificial intelligence, a decision tree, or any other logic for selecting a beauty product. The selection algorithm also may comprise maintaining in a data base beauty information on a plurality of individuals and selecting the beauty product by comparing the test results with information in the data base.

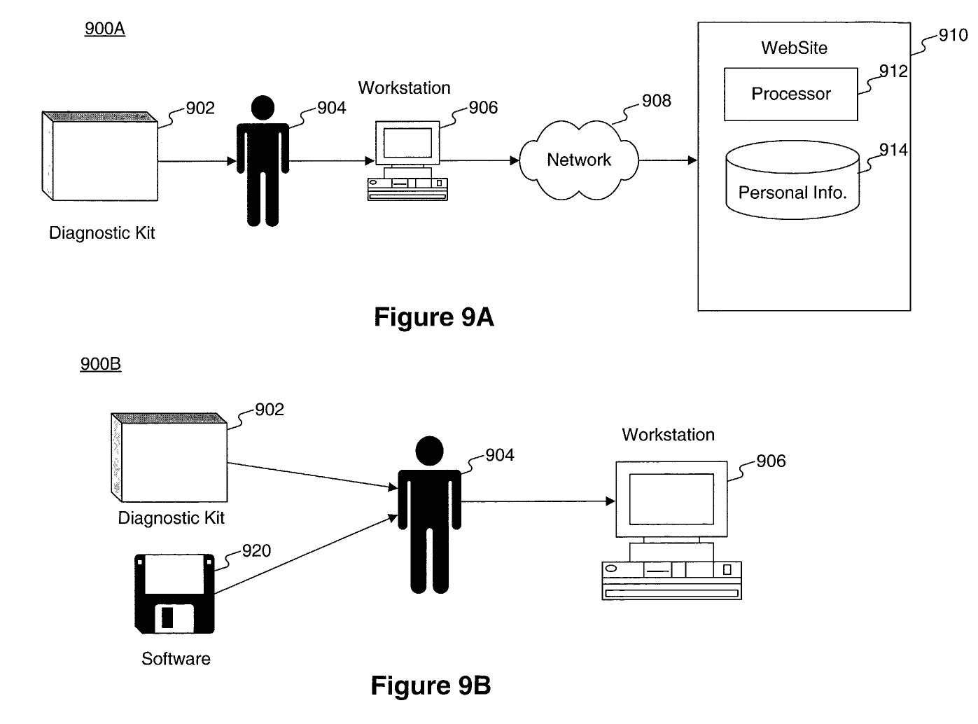

FIGS. 9A and 9B illustrates exemplary environments 900A and 900B in which the invention may be implemented. Consistent with the invention, a data structure 914 may store a plurality of questions at location remote to subject 904, as shown in FIG. 9A. Alternatively, as shown in FIG. 9B, the data structure may be provided to subject 904 on a storage medium 920, described previously above. In yet another embodiment (not shown) consistent with the invention, some of the plurality of questions may be stored at a location remote from a location of the subject, such as host website 910, and some of the plurality of questions may be stored at another location, such as on storage medium 920.

Subject 904 may receive diagnostic kit 902 by a courier or mail delivery, or subject 904 may receive diagnostic kit 902 at a designated location. As described above, diagnostic kit 902 may include one or more testing materials for conducting a physical self-test, including sebutape, pH indicators, and corneodisque indicators. The test materials also may include a image capture device and a driver for the image capture device.

The subject may receive instructions for conducting the self-test, instructions for furnishing information reflecting results of the self-test, and a subset of questions from the plurality of questions in one or more of electronic, hard copy, or telephonic format. The electronic format may be provided locally or remotely, as shown in FIGS. 9A and 9B. FIG. 9A illustrates electronically accessing a host website 910 through a subject workstation 906 via a network 908. The host website 910 may include a processor 912 and a data structure 914 for at least one of enabling a subject to access a system for presenting at least some of the plurality of questions to the subject, presenting directions for conducting at least one physical test, instructing the subject on how to furnish information reflecting results of the self test, and presenting the subset of questions to the subject.

FIG. 9B, on the other hand, illustrates providing the subject 904 with client-based software 920 configured to run on the subject's computer 906. The software may perform at least one of enabling a subject to access a system for presenting at least some of the plurality of questions to the subject, presenting directions for conducting at least one physical test, instructing the subject on how to furnish information reflecting results of the self test, and presenting the subset of questions to the subject.

Consistent with the present invention, there may be a beauty diagnostic method including receiving of information regarding at least one external body condition of a subject; based on the received information, selecting from a plurality of testing material at least one customized set of testing material; and informing the subject about the at least one customized set of testing material. In such a method, the information could be answers to personal questions, as discussed above, and/or one or more representations reflecting the external body conditions. Examples of representations include, but are not limited to, images, charts, graphs, and test results. As used herein, the term “image” includes a likeness of at least a portion of an external portion having the external body condition. For example, the image could be a conventional or digital photograph of all or a portion of the subject's face.

This application may discuss beauty products in connection with use by women. However, it is to be understood that such discussions are for exemplary purposes only. It is to be understood that the invention is equally applicable to all genders, and is not necessarily limited to the beauty industry. It is also to be understood that any functional aspect of the invention can be implemented via any location in the system or network, and data software may be resident at any location either in a network, at a stand-alone site, or on media in the custody and control of a user or subject.

It is to be further understood that the physical mechanisms (e.g. hardware, software, networks, systems) for implementing the methods of the invention are many. Networks, hardware and systems can be configured in a host of ways with software and hardware functionality residing at many alternative locations. In addition, systems other than the exemplary systems disclosed might be used to implement the invention. Therefore, it is to be understood that the methods of the invention are not limited to any particular structure.

Further, methods or portions thereof can be implemented in either an electronic environment, a physical environment, or combinations thereof. Thus, for example, although one or more portions of a method may occur in an electronic environment, a “purchase” portion of the method may occur in a brick and mortar store, or vice versa.

### Cross-Reference to Concurrently Filed Applications and Global Definitions

This application claims priority on and incorporates by reference the following U.S. Provisional applications: Artificial Intelligence For Use In Cosmetic And Non-Cosmetic Environments, Application No. 60/325,561 (provisional filed Oct. 1, 2001); and Methods And Systems For Cosmetic And Non-Cosmetic Product Selection, Application No. 60/325,559 (provisional filed Oct. 1, 2001).

The following concurrently filed U.S. patent applications are also incorporated herein by reference: Body Image Enhancement, Attorney Docket No. 05725.0972; Methods And Systems For Predicting And/Or Tracking Changes In External Body Conditions, Attorney Docket No. 05725.0973; Methods And Systems For Generating A Prognosis, Attorney Docket No. 05725.0974; Historical Beauty Record, Attorney Docket No. 05725.0975; Identification And Presentation Of Analogous Beauty Case Histories, Attorney Docket No. 05725.0976; Interactive Beauty Analysis, Attorney Docket No. 05725.0977; Feature Extraction In Beauty Analysis, Attorney Docket No. 05725.0978; Simulation Of An Aesthetic Feature On A Facial Image, Attorney Docket No. 05725.0979; Beauty Advisory System And Method, Attorney Docket No. 05725.0980; Virtual Beauty Consultant, Attorney Docket No. 05725.0981; Calibrating Image Capturing, Attorney Docket No. 05725.0982; Use Of Artificial Intelligence In Providing Beauty Advice, Attorney Docket No. 0572.0983; Shop-In-Shop Website Construction, Attorney Docket No. 05725.0984; Early Detection Of Beauty Treatment Progress, Attorney Docket No. 05725.0986; Systems And Methods For Providing Beauty Guidance, Attorney Docket No. 05725.0987; Methods And Systems Involving Simulated Application Of Beauty Products, Attorney Docket No. 05725.1008; Customized Beauty Tracking Kit, Attorney Docket No. 05725.1009; Analysis Using Three-Dimensional Facial Image Attorney Docket No. 05725.1010; Body Image Templates With Pre-Applied Beauty Products, Attorney Docket No. 05725.1011; and Image Capture Method, Attorney Docket No. 05725.1012.

To the extent not inconsistent with the invention defined herein, definitions and terminology usage in the above-mentioned concurrently filed applications, the above-mentioned priority applications, and the following global definitions are to be considered in interpreting the language of this patent and the claims herein. Where multiple definitions are provided, they should be considered as a single cumulative definition.

The term “image” may include one or more of two-dimensional and three-dimensional representations. In certain examples consistent with the invention, a plurality of images from different perspectives may be used to construct a three-dimensional image. In a broader sense, only a single image may be used. Depending on the embodiment, the term “image” may include either a visually perceptible image or electronic image data that may be either used to construct a visually perceptible image or to derive information about the subject. The image may be a body image corresponding to an anatomical portion of the subject, and may represent, for example, the subject's entire face, or a portion of the subject's face. The image may be a detailed picture (e.g., a digital image or a photograph) of a portion of the subject's body and/or a topological plot mapping contours of a portion of subject's body. If the image is representative of an external body condition, the image could be either an actual image showing the condition or an image including symbolizations of the condition, for example. The image may be an actual or a simulated image. Simulated images may include wholly or partially generated computer images, images based on existing images, and images based on stored features of a subject.

The term “image capture device”, similar terms, and terms representing structures with similar functions may include one or more of a digital camera, webcam, film camera, analog camera, digital video camera, scanner, facsimile machine, copy machine, infrared imager, ultra-sound imaging device, or any other mechanism for acquiring an image of a subject's external body condition, an image of the subject's countenance, an/or an image of the subject's skin. An ultrasonic device might provide skin thickness information, or it might create a map on an area of the external location. Thus, the term “image” as used herein may be broader than a picture. Combinations of image capture devices may be used. For example, an image captured on photographic paper using a film camera might then be scanned on a flat bed scanner to create another image.

The term “capturing (an image)”, or any form thereof, refers to the use of an image capture device to acquire an image. “Capturing” may refer to the direct act of using the image capture device to acquire the image. It may also include indirect acts to promote acquisition. To this end, “capturing” may include the indirect acts of providing access to hardware, or to at least one of a client-based algorithm and a server-based algorithm for causing the image capture device to capture an image. This may be accomplished by providing a user with software to aid in the image capture process, or providing the user with access to a network location at which the software resides. Also consistent with certain embodiments of the invention, capturing may include at least one of receiving an instruction from the subject to capture an image, indicating to the subject before the image is captured, and indicating to the subject when the image is captured.

The term “image processing technique” or similar terms, may include a software program, computer, application specific integrated circuit, electronic device and/or a processor designed to identify in an image one or more characteristics, such as a skin condition. Such techniques may involve binarization, image partitioning, Fourier transforms, fast Fourier transforms (FFTs), and/or discrete cosine transforms may be performed on all or part of the image, resulting in coefficients. Based on the coefficients, conditions may be located, as known in the art. Artificial intelligence, such as fuzzy logic, neural networks, genetic programming and decision tree programming, may also be used to identify conditions. Alternatively, one or more digital filters may be passed through the image for locating specific conditions. These examples are provided for illustrative purposes with the understanding that any image processing technique may be used.

The term “network interface” or similar terms, refer to any mechanism for aiding communications between various nodes or locations in a network. A network interface may include, for example a bus, a modem, or any other input/output structure. A network interface may permit a connection to any network capable of being connected to an input and/or output module located within at least one or more of the following exemplary networks: an Ethernet network, an Internet Protocol network, a telephone network, a radio network, a cellular network, or any mechanism for permitting communication between two or more modes or remote locations. In some invention embodiments, a network interface might also included a user interface.

The term “user interface” may include at least one component such as a keyboard, key pad, mouse, track ball, telephone, scanner, microphone, touch screen, web cam, interactive voice response system (IVR), voice recognition system or any other suitable input mechanism for conveying information. A user interface may also include an input port connected by a wired, optical, or wireless connection for electromagnetic transmissions. In some embodiments, a user interface may include connections to other computer systems to receive the input commands and data therefrom. User interface may further include a data reading device such as a disk drive for receiving input data from and writing data to storage media such as magnetic and optical disks.

As used herein terms such as “external body condition”, “skin condition”, and “actual condition” refer to conditions of at least one of the skin, teeth, hair, eyebrows, eyelashes, body hair, facial hair, fingernails, and/or toenails, or any other externality. Examples of skin conditions may include elasticity, dryness, cellulitis, sweating, aging, wrinkles, melanoma, exfoliation, desquamation, homogeneity of color, creases, liver spots, clarity, lines, micro-circulation, shininess, softness, smoothness, tone, texture, matitty, hydration, sag, suppleness, stress, springiness, firmness, sebum production, cleanliness, translucency, luminosity, irritation, redness, vasocolation, vasomotion, vasodilation, vasoconstriction, pigmentation, freckles, blemishes, oiliness, pore distribution, pore size, moles, birthmarks, acne, blackheads, whiteheads, pockmarks, warts, pustules, boils, blisters, marks, smudges, specks, psoriasis and other characteristics associated with the subject's skin. Examples of hair conditions may include keratin plug, length, dryness, oiliness, dandruff, pigmentation, thickness, density, root conditions, split ends, hair loss, hair thinning, scales, staging, cleanliness and other properties related to the subject's hair. Examples of fingernail and toenail conditions may include onychomycosis, split nails, delaminating, psoriasis, brilliancy, lines, spots, coloration, gloss, strength, brittleness, thickness, hangnail, length, disease, and other characteristics related to the subject's nails. Other conditions may include, for example, size and proportion of facial features, teeth discoloration, and any other aesthetic-related or physical, physiological, or biological conditions of the user.

“Enabling”, “facilitating”, and “causing” an action refer to one or more of a direct act of performing the action, and any indirect act of encouraging or being an accessory to the action. Thus, the terms include partnering or cooperating with an entity who performs the action and/or referring commerce to or having commerce referred from an entity who performs the action. Other examples of indirect activity encompassed within the definitions of “enabling”, “facilitating”, and “causing” may include providing a subject with one or more of tools to knowingly aid in performing the action, providing instructions on how to perform the action, providing prompts or cues to perform the action, or expressly encouraging performance of the action. Indirect activity may also include cooperating with an entity who either directly performs the action or who helps another perform the action. Tools may include software, hardware, or access (either directly, through hyperlink, or some other type of cooperation or partnering) to a network location (e.g., web site) providing tools to aid in performing the action. Thus, phrases such as “enabling access” and “enabling display” do not necessary require that the actor actually access or display anything. For example, the actor may perform the enabling function by affiliating with an entity who performs the action, or by providing instructions, tools, or encouragement for another to do the accessing and displaying.

Forms of the word “displaying” and like terms may also include indirect acts such as providing content for transmission over a network to a display device, regardless of whether the display device is in the custody or control of the sender. Any entity in a chain of delivering information for display performs an act of “displaying”, as the term is used herein.

Likewise, the term “providing” includes direct and indirect activities. For example, providing access to a computer program may include at least one of providing access over a network to the computer program, and creating or distributing to the subject a computer program configured to run on the subject's workstation or computer. For example, a first party may direct network traffic to (either through electronic links or through encouragement to visit) a server or web site run by a second party. If the second party maintains a particular piece of software thereon, then it is to be understood that within the meaning of “providing access” as used herein, the first party is said to provide access to the particular software. Or if the first party directs a subject to a second party who in turn ships the particular software to the user, the first party is said to provide the user with access to the particular software. (Of course, in both of the above instances, the second party would also be providing access within the meaning of the phrase as used herein.) “Receiving” may include at least one of acquisition via a network, via verbally communication, via electronic transmission, via telephone transmission, in hard-copy form, or through any other mechanism enabling reception. In addition, “receiving” may occur either directly or indirectly. For example, receipt may occur through a third party acting on another party's behalf, as an agent of another, or in concert with another. Regardless, all such indirect and direct actions are intended to be covered by the term “receiving” as used herein. A received request, for example, may take one of many forms. It may simply be a checked box, clicked button, submitted form or oral affirmation. Or it might be a typed or handwritten textual request. Receiving may occur through an on-line interest form, e-mail, facsimile, telephone, interactive voice response system, or file transfer protocol transmitted electronically over a network at a web site, an internet protocol address, or a network account. A request may be received from a subject for whom information is sought, or an entity acting on the subject's behalf. “Receiving” may involve receipt directly or indirectly through one or more networks and/or storage mediums. Receipt may occur physically such as in hard copy form, via mail delivery or other courier delivery.

Forms of the word “maintain” are used broadly to include gathering, storing, accessing, providing access to, or making something available for access, either directly or indirectly. For example, those who maintain information include entities who provide a link to a site of a third party where the information is stored.

Consistent with the concepts set forth above, all other recited actions such as, for example, obtaining, determining, generating, selecting, applying, simulating, presenting, etc, are inclusive of direct and indirect actions. Thus, for purposes of interpreting the following claims, an entity performs a recited action through either direct or indirect activity. Further examples of indirect activity include sending signals, providing software, providing instructions, cooperating with an entity to have the entity perform the action, outsourcing direct or indirect actions, or serving in any way as an accessory to the specified action.

The term “product” is used to generically refer to tangible merchandise, goods, services, and actions performed. A “beauty product,” “beauty care product,” “cosmetic product” or similar terms, refer to products (as defined above) for effecting one or more external body conditions, such as conditions of the skin, hair and nails. Examples of tangible merchandise forms of beauty products include cosmetic goods, such as treatment products, personal cleansing products, and makeup products, in any form (e.g., ointments, creams, gels, sprays, supplement, ingesta, inhalants, lotions, cakes, liquids, and powders.)

Examples of services forms of beauty products include hair styling, hair cutting, hair coloring, hair removal, skin treatment, make-up application, and any other offering for aesthetic enhancement. Examples of other actions performed include massages, facial rubs, deep cleansings, applications of beauty product, exercise, therapy, or any other action effecting the external body condition whether performed by a professional, the subject, or an acquaintance of the subject.

The following is exemplary and non-exhaustive listing of a few beauty products-scrubs, rinses, washes, moisturizers, wrinkle removers, exfoliates, toners, cleansers, conditioners, shampoos, cuticle creams, oils, and anti-fungal substances, anti-aging products, anti-wrinkle products, anti-freckle products, skin conditioners, skin toners, skin coloring agents, tanners, bronzers, skin lighteners, hair coloring, hair cleansing, hair styling, elasticity enhancing products, agents, blushes, mascaras, eyeliners, lip liners, lipsticks, lip glosses, eyebrow liners, eye shadows, nail polishes, foundations, concealers, dental whitening products, cellulite reduction products, hair straighteners and curlers, and weight reduction products. A beauty care treatment regimen may involve the administration of one or more products, as defined above.

The terms “beauty advice”, “beauty guidance”, and similar terms are used interchangeably to refer to the provision of beauty related information to a subject. Advice or guidance includes one or more of beauty product recommendations (e.g., cosmetic product recommendations for products to treat conditions the subject is prompted to evaluate), remedial measures, preventative measures, predictions, prognoses, price and availability information, application and use information, suggestions for complementary products, lifestyle or dietary recommendations, or any other information intended to aid a subject in a course of future conduct, to aid a subject in understanding past occurrences, to reflect information about some future occurrences related to the subject's beauty or to aid a subject in understanding beauty products, as defined above.

The term “network” may include a public network such as the Internet or a telephony network, a private network, a virtual private network, or any other mechanism for enabling communication between two or more nodes or locations. The network may include one or more of wired and wireless connections. Wireless communications may include radio transmission via the airwaves, however, those of ordinary skill in the art will appreciate that various other communication techniques can be used to provide wireless transmission including infrared line of sight, cellular, microwave, satellite, blue-tooth packet radio and spread spectrum radio. Wireless data may include, but is not limited to, paging, text messaging, e-mail, Internet access and other specialized data applications specifically excluding or including voice transmission.

In some instances consistent with the invention, a network may include a courier network (e.g. postal service, United Parcel Service, Federal Express, etc.). Other types of networks that are to be considered within the scope of the invention include local area networks, metropolitan area networks, wide area networks, ad hoc networks, or any mechanism for facilitating communication between two nodes or remote locations.

“Artificial intelligence” (AI) is used herein to broadly describe any computationally intelligent systems that combine knowledge, techniques, and methodologies. An AI engine may be any system configured to apply knowledge and that can adapt itself and learn to do better in changing environments. Thus, the AI engine may employ any one or combination of the following computational techniques: neural network, constraint program, fuzzy logic, classification, conventional artificial intelligence, symbolic manipulation, fuzzy set theory, evolutionary computation, cybernetics, data mining, approximate reasoning, derivative-free optimization, decision trees, or soft computing. Employing any computationally intelligent techniques, the AI engine may learn to adapt to unknown or changing environment for better performance. AI engines may be implemented or provided with a wide variety of components or systems, including one or more of the following: central processing units, co-processors, memories, registers, or other data processing devices and subsystems.

AI engines may be trained based on input such as product information, expert advice, user profile, or data based on sensory perceptions. Using input an AI engine may implement an iterative training process. Training may be based on a wide variety of learning rules or training algorithms. For example, the learning rules may include one or more of the following: back-propagation, real-time recurrent learning, pattern-by-pattern learning, supervised learning, interpolation, weighted sum, reinforced learning, temporal difference learning, unsupervised learning, or recording learning. As a result of the training, AI engine may learn to modify its behavior in response to its environment, and obtain knowledge. Knowledge may represent any information upon which AI engine may determine an appropriate response to new data or situations. Knowledge may represent, for example, relationship information between two or more products. Knowledge may be stored in any form at any convenient location, such as a database.

Since AI engine may learn to modify its behavior, information describing relationships for a universe of all combinations of products may not need to be maintained by the AI engine or any other component of the system.

“Personal information”, “subject specific information”, “user specific information”, “user profile”, “personal characteristics”, “personal attributes”, “profile information”, and like terms (collectively referred to in this section as “personal information”) may broadly encompass any information about the subject or user. Such information may, for example, fall within categories such as physical characteristics, fashion preferences, demographics, nutritional information, cosmetic usage information, medical history information, environmental information, beauty product usage information, lifestyle, and may include information such as name; age; birth date; height; weight; ethnicity; eating habits; vacation patterns; geographic location of the individual's residence, location, or work; work habits; sleep habits; toiletries used; exercise habits; relaxation habits; beauty care habits; smoking and drinking habits; sun exposure habits; use of sunscreen; propensity to tan; number of sunburns and serious sunburns; dietary restrictions; dietary supplements or vitamins used; diagnosed conditions affecting the external body, such as melanoma; an image, such as a picture or a multimedia file of the subject; facial feature characteristics; family history information such as physical characteristics information about relatives of the subject (e.g., premature balding, graying, wrinkles, etc.); external body condition (as defined previously); color preferences, clothing style preferences, travel habits; entertainment preferences; fitness information; adverse reactions to products, compounds, or elements (e.g., sun exposure); body chemistry, use of prior beauty care products and their effectiveness; purchasing, shopping, and browsing habits; hobbies; marital status; whether the subject is a parent; country of residence; region of residence; birth country and region; religious affiliation; political affiliation; whether the subject is an urban dweller suburban dweller or rural area dweller; size of urban area in which the subject lives; whether the subject is retired; annual income, sexual preference, or any other information reflecting habits, preferences, or affiliations of the subject.

Personal information may also include information electronically gleaned by tracking the subject's electronic browsing or purchasing habits, or as the result of cookies maintained on the subject's computer, responses to surveys, or any other mechanism providing information related to the subject. In addition, personal information may be gathered through non-electronic mechanisms such as hard copy surveys, personal interviews, or consumer preference polls.

“Complementary” and “complementary product” refers to one or more of physical, physiological, biologically, and aesthetic compatibility. A product may be complementary with one or more of another product, a group of products, or a subject. In that latter instance, whether a product is considered “complementary” may be a function of personal information of the subject. Thus, for example a product may be complementary if it is unlikely to cause an adverse allergic reaction; if it physically blends well with another product; or if it is aesthetically consistent with the subject or one or more other products. Aesthetic compatibly may refer to the fact that two products are aesthetically appealing (or do not clash) when worn together. The identification of a complementary product may also be based on product characteristics, user preferences, survey data, or expert advice.

As used herein, the words “may” and “may be” are to be interpreted in an open-ended, non-restrictive manner. At minimum, “may” and “may be” are to be interpreted as definitively including structure or acts recited. Further, the word “or” is to be interpreted in the conjunctive and the disjunctive.

While flow charts presented herein illustrate a series of sequential blocks for exemplary purposes, the order of blocks is not critical to the invention in its broadest sense. Further, blocks may be omitted and others added without departing from the spirit of the invention. Also, the invention may include combinations of features described in connection with differing embodiments.

Although a focus of the disclosure may be on server-side methods, it is nevertheless to be understood that the invention includes corresponding client-side methods, software, articles of manufacture, and computer readable media, and that computer readable media can be used to store instructions for some or all of the methods described herein. Further, it is to be understood that disclosed structures define means for implementing the functionality described herein, and that the invention includes such means for performing the disclosed functions.

In the foregoing Description of Exemplary Embodiments, various features are grouped together in a single embodiment for purposes of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Description of the Exemplary Embodiments, with each claim standing on its own as a separate embodiment of the invention.

What is claimed is:

1. A beauty analysis method, comprising:
storing in a data structure a plurality of questions related to beauty;
enabling a subject to access a system for presenting at least some of the plurality of questions to the subject;
presenting to the subject directions for conducting at least one physical self-test;
instructing the subject on how to furnish information reflecting results of the self-test;
selecting, from the plurality of questions, a subset of questions to be presented to the subject, wherein a number of questions contained in the subset and identities of questions contained in the subset are a function of the furnished information; and
presenting the subset of questions to the subject.

2. The method of claim 1, further comprising causing physical transmission to the subject of a package containing materials for conducting the at least one self-test.

3. The method of claim 2, wherein the package further contains at least one of an image capture device and a driver for an image capture device, and wherein the method further comprises encouraging the subject to conduct an auto-evaluation using the image capture device.

4. The method of claim 1, wherein the system includes a network, and wherein the at least some of the plurality of questions are stored at a location remote from a location of the subject.

5. The method of claim 1, wherein enabling a subject to access a system includes providing the subject with software configured to run on the subject's computer.

6. The method of claim 2, wherein the materials include at least one of a pH indicator, sebutape, and a corneodisque indicator.

7. The method of claim 1, wherein presenting directions for conducting at least one physical self-test includes at least one of transmitting instructions to the subject over a network, providing instructions to the subject in the form of software, and providing instructions to the subject in hard-copy form.

8. The method of claim 1, wherein instructing the subject on how to furnish information reflecting results of the self-test includes directing the subject on how to interpret the results of the self-test and directing the subject on how to provide the interpreted results to at least one of a client-based processor and a network-based processor.

9. The method of claim 1, wherein selecting a subset of questions includes providing at least one of a client-based algorithm and a server-based algorithm for narrowing the plurality of questions to the subset of questions as a function of the information reflecting results of the self-test.

10. The method of claim 9, wherein the algorithm is based on artificial intelligence.

11. The method of claims 9, further comprising maintaining in a data base, beauty information on a plurality of individuals, and wherein the algorithm narrows the plurality of questions to the subset of questions by comparing subject provided information with information in the data base.

12. The method of claim 1, further comprising receiving a response from the subject to the subset of questions, and prescribing at least one beauty product to the subject as a function of at least one of the self test information and at least some of the responses to the subset of questions.

13. A beauty analysis method, comprising:
storing in a data structure a plurality of questions related to beauty;
enabling a subject to access a system for presenting at least some of the plurality of questions to the subject;
presenting at least a first question subset from the plurality of questions to the subject;
receiving a first response set to the first question subset;
identifying, as a function of the first response set, at least one physical self-test to be conducted by the subject;
presenting directions for conducting the at least one physical self-test to the subject;
instructing the subject on how to furnish information reflecting results of the physical self-test;
identifying a second question subset chosen from the plurality of questions, wherein a make-up of the second question subset is at least partially a function of the furnished information;
presenting the second question subset to the subject;
receiving a second response set to the second question subset; and
prescribing at least one beauty product to the subject as a function of the first response set, the second response set, and the information reflecting results of the physical self-test.

14. The method of claim 13, further comprising physically transmitting to the subject a package containing materials for conducting the at least one physical self-test.

15. The method of claim 14, wherein the package further contains at least one of an image capture device and a driver for an image capture device, and wherein the method further comprises encouraging the subject to conduct an auto-evaluation using the image capture device.

16. The method of claim 13, wherein the system includes a network, and wherein the at least some of the plurality of questions are stored at a location remote from a location of the subject.

17. The method of claim 13, wherein enabling a subject to access a system includes providing the subject with client-side software.

18. The method of claim 14, wherein the materials include at least one of a pH indicator, sebutape, and a corneodisque indicator.

19. The method of claim 13, wherein presenting directions for conducting at least one physical self-test includes at least one of transmitting instructions to the subject over a network, providing instructions to the subject in the form of software, and providing instructions to the subject in hard-copy form.

20. The method of claim 13, wherein instructing the subject on how to furnish information reflecting results of the self-test includes directing the subject on how to interpret the results of the self-test and directing the subject on how to provide the interpreted results to at least one of a client-based processor and a network-based processor.

21. The method of claim 13, wherein identifying, as a function of the first response set, at least one physical self-test to be conducted by the subject, is accomplished using a selection algorithm.

22. The method of claim 13, wherein at least one of identifying a second question subset and prescribing a beauty product is accomplished using a selection algorithm.

23. The method of claim 21, wherein the selection algorithm employs artificial intelligence.

24. The method of claims 23, further comprising maintaining in a data base, beauty information on a plurality of individuals, and wherein the algorithm compares information about the subject with information in the data base.

25. A beauty analysis system, comprising:
means for storing a plurality of questions related to beauty;
means for enabling a subject to access a system for presenting at least some of the plurality of questions to the subject;
means for presenting directions for conducting at least one physical self-test to the subject;
means for instructing the subject on how to furnish information reflecting results of the self-test;
means for selecting, from the plurality of questions, a subset of questions to be presented to the subject, wherein a number of questions contained in the subset and identities of questions contained in the subset are a function of the furnished information; and
means for presenting the subset of questions to the subject.

26. The system of claim 25, further comprising means for causing physical transmission to the subject of a package containing materials for conducting the at least one self-test.

27. The system of claim 26, wherein the package further contains at least one of an image capture device and a driver for an image capture device, and wherein the system further comprises means for encouraging the subject to conduct an auto-evaluation using the image capture device.

28. The system of claim 25, wherein the system for presenting questions includes a network, and wherein the at least some of the plurality of questions are stored at a location remote from a location of the subject.

29. The system of claim 25, wherein means for enabling a subject to access a system includes means for providing the subject with software configured to run on the subject's computer.

30. The system of claim 26, wherein the materials include at least one of a pH indicator, sebutape, and a corneodisque indicator.

31. The system of claim 25, wherein means for presenting directions for conducting at least one physical self-test includes at least one of means for transmitting instructions to the subject over a network, means for providing instructions to the subject in the form of software, and means for providing instructions to the subject in hard-copy form.

32. The system of claim 25, wherein means for instructing the subject on how to furnish information reflecting results of the self-test includes means for directing the subject on how to interpret the results of the self-test and means for directing the subject on how to provide the interpreted results to one or more of a client-based processor and a network-based processor.

33. The system of claim 25, wherein means for selecting a subset of questions includes at least one of a client-based algorithm and a server-based algorithm for narrowing the plurality of questions to the subset of questions as a function of the information reflecting results of the self-test.

34. The system of claim 33, wherein the algorithm is based on artificial intelligence.

35. The system of claims 33, further comprising means for maintaining in a data base, beauty information on a plurality of individuals, and wherein the algorithm narrows the plurality of questions to the subset of questions by comparing subject provided information with information in the data base.

36. The system of claim 25, further comprising means for receiving a response from the subject to the subset of questions, and means for prescribing at least one beauty product to the subject as a function of at least one of the self test information and at least some of the responses to the subset of questions.

37. A beauty analysis system, comprising:
means for storing in a data structure a plurality of questions related to beauty;
means for enabling a subject to access a system for presenting at least some of the plurality of questions to the subject;
means for presenting at least a first question subset from the plurality of questions to the subject;
means for receiving a first response set to the first question subset;
means for identifying, as a function of the first response set, at least one physical self-test to be conducted by the subject;
means for presenting directions for conducting the at least one physical self-test to the subject;
means for instructing the subject on how to furnish information reflecting results of the physical self-test;
means for identifying a second question subset chosen from the plurality of questions, wherein a make-up of the second question subset is at least partially a function of the furnished information;
means for presenting the second question subset to the subject;
means for receiving a second response set to the second question subset; and
means for prescribing at least one beauty product to the subject as a function of the first response set, the second response set, and the information reflecting results of the physical self-test.

38. The system of claim 37, further comprising means for physically transmitting to the subject a package containing materials for conducting the at least one physical self-test.

39. The system of claim 38, wherein the package further contains at least one of an image capture device and a driver for an image capture device, and wherein the method further comprises encouraging the subject to conduct an auto-evaluation using the image capture device.

40. The system of claim 37, wherein the system for presenting includes a network, and wherein the at least some of the plurality of questions are stored at a location remote from a location of the subject.

41. The system of claim 37, wherein means for enabling a subject to access a system includes means for providing the subject with client-side software.

42. The system of claim 38, wherein the materials include at least one of a pH indicator, sebutape, and a corneodisque indicator.

43. The system of claim 37, wherein means for presenting directions for conducting at least one physical self-test includes at least one of means for transmitting instructions to the subject over a network, means for providing instructions to the subject in the form of software, and means for providing instructions to the subject in hard-copy form.

44. The system of claim 37, wherein means for instructing the subject on how to furnish information reflecting results of the self-test includes means for directing the subject on how to interpret the results of the self-test and means for directing the subject on how to provide the interpreted results to one or more of a client-based processor and a network-based processor.

45. The system of claim 37, wherein means for identifying, as a function of the first response set, at least one physical self-test to be conducted by the subject, is accomplished using a selection algorithm.

46. The system of claim 37, wherein at least one of means for identifying a second question subset and means for prescribing a beauty product is accomplished using a selection algorithm.

47. The system of claim 46, wherein the selection algorithm employs artificial intelligence.

48. The system of claims 47, further comprising means for maintaining in a data base, beauty information on a plurality of individuals, and wherein the algorithm compares information about the subject with information in the data base.

49. A computer program product for performing a beauty analysis, the computer program product comprising computer-readable media having computer-readable code, the computer program product comprising the following computer-readable program code for effecting actions in a computing platform:
program code for storing in a data structure a plurality of questions related to beauty;
program code for enabling a subject to access a system for presenting at least some of the plurality of questions to the subject;
program code for presenting directions for conducting at least one physical self-test to the subject;
program code for instructing the subject on how to furnish information reflecting results of the self-test;
program code for selecting, from the plurality of questions, a subset of questions to be presented to the subject, wherein a number of questions contained in the subset and identities of questions contained in the subset are a function of the furnished information; and
program code for presenting the subset of questions to the subject.

50. The computer program product of claim 49, further comprising program code for causing physical transmission to the subject of a package containing materials for conducting the at least one self-test.

51. The computer program product of claim 49, wherein program code for enabling a subject to access a system includes program code configured to run on the subject's computer.

52. The computer program product of claim 49, wherein program code for presenting directions for conducting at least one physical self-test includes at least one of program code for transmitting instructions to the subject over a network, program code for providing instructions to the subject in the form of software, and program code for providing instructions to the subject in hard-copy form.

53. The computer program product of claim 49, wherein program code for instructing the subject on how to furnish information reflecting results of the self-test includes program code for directing the subject on how to interpret the results of the self-test and program code for directing the subject on how to provide the interpreted results to one or more of a client-based processor and a network-based processor.

54. The computer program product of claim 49, wherein program code for selecting a subset of questions includes program code for at least one of a client-based algorithm and a server-based algorithm for narrowing the plurality of questions to the subset of questions as a function of the information reflecting results of the self-test.

55. The computer program product of claim 54, wherein the program code is based on artificial intelligence.

56. The computer program product of claims 54, further comprising program code for maintaining in a data base, beauty information on a plurality of individuals, and wherein the program code narrows the plurality of questions to the subset of questions by comparing subject provided information with information in the data base.

57. The computer program product of claim 49, further comprising program code for receiving a response from the subject to the subset of questions, and program code for prescribing at least one beauty product to the subject as a function of at least one of the self test information and at least some of the responses to the subset of questions.

58. A computer program product for performing a beauty analysis, the computer program product comprising computer-readable media having computer-readable code, the computer program product comprising the following computer-readable program code for effecting actions in a computing platform:
program code for storing in a data structure a plurality of questions related to beauty;
program code for enabling a subject to access a system for presenting at least some of the plurality of questions to the subject;
program code for presenting at least a first question subset from the plurality of questions to the subject;
program code for receiving a first response set to the first question subset;
program code for identifying, as a function of the first response set, at least one physical self-test to be conducted by the subject;
program code for presenting directions for conducting the at least one physical self-test to the subject;
program code for instructing the subject on how to furnish information reflecting results of the physical self-test;
program code for identifying a second question subset chosen from the plurality of questions, wherein a make-up of the second question subset is at least partially a function of the furnished information;
program code for presenting the second question subset to the subject;
program code for receiving a second response set to the second question subset; and
program code for prescribing at least one beauty product to the subject as a function of the first response set, the second response set, and the information reflecting results of the physical self-test.

59. The computer program product of claim 58, further comprising program code for physically transmitting to the subject a package containing materials for conducting the at least one physical self-test.

60. The computer program product of claim 58, wherein program code for presenting directions for conducting at least one physical self-test includes at least one of program code for transmitting instructions to the subject over a network, program code for providing instructions to the subject in the form of software, and program code for providing instructions to the subject in hard-copy form.

61. The computer program product of claim 58, wherein instructing the subject on how to furnish information reflecting results of the self-test includes directing the subject on how to interpret the results of the self-test and directing the subject on how to provide the interpreted results to one or more of a client-based processor and a network-based processor.

62. The computer program product of claim 58, wherein program code for identifying, as a function of the first response set, at least one physical self-test to be conducted by the subject, is accomplished using a selection algorithm.

63. The computer program product of claim 58, wherein at least one of program code for identifying a second question subset and program code for prescribing a beauty product is accomplished using a selection algorithm.

64. The computer program product of claim 63, wherein the selection algorithm employs artificial intelligence.

65. The computer program product of claim 64, further comprising program code for maintaining in a data base, beauty information on a plurality of individuals, and wherein the algorithm compares information about the subject with information in the data base.

66. The method of claim 22, wherein the selection algorithm employs artificial intelligence.

67. The system of claim 45, wherein the selection algorithm employs artificial intelligence.

68. A beauty analysis method, comprising:
accessing a data structure containing a plurality of questions;
presenting to a subject at least one of the plurality of questions;
receiving at least one answer to the at least one question;
based on the received at least one answer, identifying at least one physical test to be conducted on the subject, the test providing results relating to a beauty analysis; and
instructing the subject to perform the test.

69. The method of claim 68, further comprising receiving information reflective of the results of the test.

70. The method of claim 69, further comprising, based on the information, selecting at least one additional question from the plurality of questions for presentation to the subject.

71. The method of claim 69, wherein receiving information includes receiving the information via a network.

72. The method of claim 68, wherein at least a portion of the data structure is located at a location remote from the subject.

73. A beauty analysis method, comprising:
presenting to a subject directions for conducting at least one physical self-test;
receiving information reflecting results of the test;
selecting, from a plurality of questions stored in a data structure, at least one question to be presented to the subject, wherein the selecting of at least one question is a function of the received information; and
presenting the at least one selected question to the subject.

74. The method of claim 73, wherein receiving information includes receiving the information via a network.

75. The method of claim 73, wherein at least a portion of the data structure is located at a location remote from the subject.

76. A beauty analysis method, comprising:
presenting at least one question to a subject;
receiving a response to the at least one question;
identifying, as a function of the response, at least one physical self-test to be conducted by the subject;
presenting directions for conducting the at least one physical self-test to the subject;
receiving information reflecting results of the physical self-test; and
prescribing at least one beauty product to the subject as a function of at least the information reflecting results of the physical self-test.

77. The method of claim 76, wherein receiving information includes receiving the information via a network.

78. The method of claim 76, wherein the at least one question is stored in at least a portion of the data structure located at a location remote from the subject.
